(19) United States
(12) Patent Application Publication
(10) Pub. No.: US 2026/0152907 A1
(43) Pub. Date: Jun. 4, 2026

(54) ROAD CONSTRUCTION MACHINE WITH PARALLEL HYBRID DRIVE

(71) Applicant: JOSEPH VÖGELE AG, Ludwigshafen/Rhein (DE)

(72) Inventors: Stefan SIMON, Neuhofen (DE); Ralf WEISER, Ladenburg (DE); Jan SIEBERT, Karlsruhe (DE)

(73) Assignee: JOSEPH VÖGELE AG, Ludwigshafen/Rhein (DE)

(21) Appl. No.: 19/401,899

(22) Filed: Nov. 26, 2025

(30) Foreign Application Priority Data
Nov. 29, 2024 (EP) 24216450.7

(51) Int. Cl. E01C 19/48; B60K 6/48

(52) U.S. Cl. CPC E01C 19/4873; B60K 6/48; B60K 2006/4825; E01C 2301/04; E01C 2301/10

(57) ABSTRACT

The disclosure relates to a road construction machine, in particular, a paving machine or a feeder. The road construction machine comprises a primary drive, an electric machine, a transmission, and at least one load connected to the transmission. The primary drive and the electric machine are also connected to the transmission, in particular, in a force-transmitting, power-transmitting, and/or energy-transmitting manner. The electric machine is configured to be operated as a generator and a motor. The disclosure further relates to a method for operating a road construction machine and the use of a parallel hybrid drive in a road construction machine.

### CROSS-REFERENCE TO RELATED APPLICATIONS

This application claims foreign priority benefits under 35 U.S.C. § 119(a)-(d) to European patent application number 24216450.7, filed Nov. 29, 2024, which is incorporated by reference in its entirety.

### TECHNICAL FIELD

The present disclosure relates to a road construction machine, a method for operating a road construction machine, and the use of a parallel hybrid drive in a road construction machine. The road construction machine is, in particular, a paving machine.

### BACKGROUND

The use of hybrid drives, i.e., the combination of a primary drive, in particular, an internal combustion engine, and an electric drive, in road construction machines is known. However, prior art teaches only the use of serial hybrid drives in road construction machines, in particular, in paving machines.

For example, a paving machine is known from EP2333158B1 comprising a generator supplied with electrical energy from a primary energy source. Other serial hybrid drives in paving machines are known from CN112195730A and DE9308802U1.

Serial hybrid drives have inter alia the disadvantage that the energy generated by the primary drive must frequently be converted. In addition, the primary drive and the electric drive or electric generator, respectively, must be sized sufficiently large so that both can transmit the required rated power of the drive train.

### SUMMARY

An object of the present disclosure is to provide a compact and efficient drive concept for a road construction machine. This object is satisfied by a road construction machine according to the disclosure, a method for operating a road construction machine according to the disclosure, or a use of a parallel hybrid drive in a road construction machine according to the disclosure.

According to a first aspect of the disclosure, a road construction machine comprises a primary drive, an electric machine, a transmission, and at least one load. The at least one load is connected to the transmission, in particular, to an output of the transmission. The connection between the load and the transmission is, in particular, a force-transmitting, power-transmitting, and/or energy-transmitting connection. Preferably, the connection between the load and the transmission is a force-transmitting connection. The primary drive and the electric machine are connected to the transmission. The connection between the primary drive and the transmission is, in particular, a force-transmitting, power-transmitting, and/or energy-transmitting connection. The connection between the primary drive and the transmission is preferably a force-transmitting connection. The connection between the electric machine and the transmission is, in particular, a force-transmitting, power-transmitting, and/or energy-transmitting connection. The connection between the electric machine and the transmission is preferably a force-transmitting connection. A force-transmitting connection is understood to be, in particular, a connection with which mechanical energy, or a force and/or a torque, respectively, can be transmitted from a first component to a second component. The term “force-transmitting” can be understood to mean, in particular, that no (intermediate) conversion into electrical energy takes place. The force-transmitting connection can comprise multiple components, meaning that force transmission can also take place indirectly. The force-transmitting connection can comprise the interim conversion of the force or torque, respectively, into hydraulic energy. A power-transmitting connection can be understood to mean, in particular, a connection with which mechanical energy, or a force, and/or a torque, can be transmitted from a first component to a second component without being converted into electrical energy.

The road construction machine can comprise one or more primary drives. The road construction machine can comprise one or more electric machines. The road construction machine can comprise one or more transmissions.

The electric machine designed, formed, and/or configured to be operated both as a generator as well as a motor. The electric machine can be configured to convert mechanical energy generated by the primary drive into electrical energy when operated as a generator. The electric machine can be configured to convert electrical energy into mechanical energy when operated as a motor and, in particular, to drive the transmission therewith.

The primary drive and the electric machine are configured, in particular, as a parallel hybrid drive.

The force-transmission, power-transmission, and/or energy-transmission between the transmission and the primary drive can be effected, in particular, mechanically and/or hydraulically. The force-transmission, power-transmission, and/or energy-transmission between the transmission and the electric machine can be effected, in particular, hydraulically and/or mechanically. The force-transmission, power-transmission, and/or energy-transmission between the load and the primary drive can be effected, in particular, hydraulically and/or mechanically.

The mechanical energy generated by the primary drive is transmitted, in particular, directly to the transmission and not, for example, previously converted into electrical energy.

The electric machine is configured, in particular, to be operated as a motor and generator. When operated as a generator, the electric machine can generate electrical energy, in particular, from mechanical energy that is transmitted from the primary drive via the transmission to the electric machine. When operated as a motor, the electric machine can be operated with electrical energy and drive the transmission, in particular, together with the primary drive. This can relieve the burden on the primary drive or bridge failures of the primary drive. The primary drive can be operated close to the point of optimal consumption by selectively switching on the electric machine. Furthermore, the primary drive can be sized to be smaller since load peaks can be compensated for by switching on the electric machine.

This hybrid design reduces fuel consumption and noise emissions in particular.

The primary drive can be configured to shut down automatically during a paving stop of the road construction machine. The at least one load can be supplied with energy from a battery during the paving stop. The battery is described in more detail below.

The road construction machine can comprise a screed heating system. The road construction machine can comprise one or more auxiliary drives. The screed heating system is given merely as an example and can also represent a different electrical load or auxiliary drive. The person skilled in the art will understand that the following discussion and explanations regarding the screed heating system also apply to other electrical loads or auxiliary drives, respectively. The screed heating system and/or other electrical loads can be supplied with energy from the battery during the paving stop.

The transmission is, in particular, a transfer gearing. The transmission is, in particular, a pump transfer gearing. The transmission, in particular, the pump transfer gearing, is configured, in particular, to transmit mechanical energy, in particular, to at least one load.

The road construction machine is, in particular, a paving machine or a feeder vehicle for a paving machine. The paving machine is configured to produce a paving layer from a paving material.

The primary drive and the electric machine can each be connected to the transmission directly or by way of a clutch, for example, a hydraulic clutch and/or friction clutch. For example, the primary drive can be connected directly to the transmission, and the electric machine can be connected to the transmission by way of a clutch, for example, a hydraulic clutch and/or friction clutch, or vice versa. The primary drive and the electric machine can each be connected directly to the transmission. The primary drive and the electric machine can each be connected to the transmission via a hydraulic clutch. In particular, force-transmission, power-transmission, and/or energy-transmission takes place from the primary drive to the transmission, if necessary via possible intermediate members. In particular, force-transmission, power-transmission, and/or energy-transmission occurs from the electric machine to the transmission or from the transmission to the electric machine, respectively, possibly via intermediate members. The term “direct” can be understood, in particular, to mean that no conversion into electrical energy takes place between the primary drive and the transmission or between the electric machine and the transmission, respectively. Any other configuration of a clutch can also be employed.

In this configuration, the transmission is arranged, in particular, between the primary drive and the electric machine. The primary drive can be connected to a drive of the transmission. The electric machine can be connected to an output of the transmission. The mechanical energy generated by the primary drive can be transmitted from the primary drive to the electric machine via the transmission.

The electric machine can be connected to the transmission directly or by way of a clutch, for example, a hydraulic clutch and/or friction clutch. The primary drive can be connected to the transmission indirectly, in particular, via the electric machine. In this case, the electric machine is configured, in particular, as a crankshaft generator. The electric machine can be arranged between the primary drive and the transmission. The electric machine can be connected to the primary drive.

The road construction machine can be formed or configured such that no conversion into electrical energy takes place between the primary drive and the transmission. In particular, no conversion of mechanical energy generated by the primary drive into electrical energy can take place. The energy generated by the primary drive can be transmitted to the transmission without the energy being converted into electrical energy in the meantime. The primary drive generates, in particular, mechanical energy. This mechanical energy is transmitted, in particular, directly to the transmission, i.e., without conversion into electrical energy. The transmission of mechanical energy from the primary drive to the transmission can occur via one or more intermediate members, i.e., the transmission can occur directly or indirectly. The transmission of mechanical energy from the primary drive to the transmission can occur via the electric machine, where the latter is configured, in particular, as a crankshaft generator in such a case. The transmission of mechanical energy from the primary drive to the transmission can occur by way of a clutch, for example, a hydraulic clutch and/or friction clutch. The transmission of mechanical energy from the primary drive to the transmission can include the conversion into hydraulic energy. The transmission of mechanical energy from the primary drive to the transmission comprises, in particular, no conversion into electrical energy.

The road construction machine can be formed or configured such that no conversion into electrical energy takes place between the primary drive and the at least one load. An exception to this can be electrical loads, where the conversion into electrical energy necessarily occurs beforehand.

The road construction machine can comprise a battery, in particular, a high-voltage battery. High voltage means, in particular, 30 volts to 1000 volts for alternating voltage or 60 volts to 1500 volts for direct voltage. The electric machine can be configured to charge the battery with energy generated, in particular, when operated as a generator. The electric machine can be configured to be operated with energy from the battery, in particular, when operated as a motor. The battery of a road construction machine with a rated motor power of less than 200 kW can comprise a capacity of 10 kWh to 100 kWh.

Such an arrangement can be more compact than compared to the arrangement described above. Such an arrangement can comprise installation space advantages.

The primary drive can drive the transmission mechanically. The mechanical energy generated by the primary drive is transmitted, in particular, to the transmission without first being converted into electrical energy. A torque generated by the primary drive or a rotation generated is transmitted, in particular, to the transmission.

The primary drive can comprise an internal combustion engine, in particular, consist of an internal combustion engine. The primary drive can comprise a diesel engine, in particular, consist of a diesel engine. The primary drive can comprise a gasoline engine, in particular, consist of a gasoline engine. The primary drive can comprise a hydrogen engine, in particular, consist of a hydrogen engine. The primary drive can comprise a gas engine, in particular, consist of a gas engine.

The electric machine can be an electromagnetic converter, for example, a permanent-magnet synchronous machine (PSM). The electromagnetic converter can be a permanent magnet synchronous machine, an asynchronous machine, a reluctance machine, an externally excited synchronous machine, or a combination thereof. The permanent magnet synchronous machine can be connected to an output of the transmission. The transmission can be arranged between the permanent magnet synchronous machine and the primary drive. The permanent magnet synchronous machine can be operated as a generator using mechanical energy generated by the primary drive which is transmitted, in particular, via the transmission to the permanent magnet synchronous machine. The permanent magnet synchronous machine can be operated as a motor to drive the transmission.

The permanent magnet synchronous machine can be connected to a drive of the transmission. The permanent magnet synchronous machine can be connected to the primary drive. The permanent magnet synchronous machine can be arranged between the primary drive and the transmission. The permanent magnet synchronous machine can represent a crankshaft generator.

The electric machine can be an externally excited synchronous machine. The externally excited synchronous machine can be arranged at an output of the transmission. The transmission can be arranged between the externally excited synchronous machine and the primary drive. The externally excited synchronous machine can be operated as a generator using mechanical energy generated by the primary drive which is transmitted, in particular, via the transmission to the externally excited synchronous machine. The externally excited synchronous machine can be operated as a motor to drive the transmission. During the paving state, the externally excited synchronous machine can be connected to the screed heating system, in particular, to supply the screed heating system with energy. During the paving stop, the externally excited synchronous machine can be disconnected from the screed heating system.

The electric machine can be an asynchronous machine. The asynchronous machine can be arranged at an output of the transmission. The transmission can be arranged between the asynchronous machine and the primary drive. The asynchronous machine can be operated as a generator using mechanical energy generated by the primary drive which is transmitted, in particular, via the transmission to the asynchronous machine. The asynchronous machine can be operated as a motor to drive the transmission.

The electric machine can be a reluctance motor. The electric machine can be a combination of a synchronous machine and an asynchronous machine.

The at least one load can comprise a pump with a variable or constant displacement volume, a travel drive, a transverse distribution device, and/or a material transport device. The pump can be connected to an output of the transmission, in particular, in a manner that can be coupled or switched. The travel drive, in particular, a pump associated with the travel drive, can be connected to an output of the transmission, in particular, in a manner that can be coupled or switched, respectively. The transverse distribution device, in particular, a pump associated with the transverse distribution device, can be connected to an output of the transmission, in particular, in a manner that can be coupled or switched. The material transport device, in particular, a pump associated with the material transport device, can be connected to an output of the transmission, in particular, in a manner that can be coupled or switched. The pump, the travel drive, the transverse distribution device, and/or the material transport device, or their associated pumps, respectively, can be connected to the transmission at different points on the transmission. The above-mentioned pumps are, in particular, hydraulic pumps. The hydraulic pumps are configured, in particular, to convert mechanical energy into hydraulic energy.

Hydraulic pumps and motors can comprise a variable or constant displacement volume. With a variable displacement pump, the power flow to a hydraulic motor connected thereto can be interrupted, for example, by pivoting the pump back, without there being a need for a mechanical coupling.

Through the connectable or switchable connections between the transmission and the load(s) and/or by pivoting back a pump with variable displacement, the corresponding loads can be disconnected from the primary drive or the electric machine.

The connection between the electric machine, in particular, the permanent magnet synchronous machine, and the transmission can be configured in a manner that can be coupled or switched. The connection in a manner that can be coupled or switched allows for the electric machine to be disconnected from the transmission in order to create no drag losses in the electric machine, in particular, in a state in which the electric machine is neither operating as a generator nor as a motor and the primary drive is running.

The connection between the primary drive, in particular, the combustion engine, and the transmission can be configured in a manner that can be coupled or switched. This allows for the road construction machine to be operated purely electrically. The electric machine, in particular, the permanent magnet synchronous machine, is operated, in particular, as a motor and drives the transmission.

The road construction machine can comprise a Direct voltage network/DC network. The battery can be arranged in the Direct voltage network. The battery can be connected to or joined with the Direct voltage network. The electric machine can be connected to or joined with the Direct voltage network. The screed heating system can be arranged in the Direct voltage network. The screed heating system can be connected to or joined with the Direct voltage network. A first power converter, in particular, a first inverter, can be arranged between the screed heating system and the Direct voltage network. In addition, a first transformer can be arranged between the screed heating system and the first power converter/inverter. The auxiliary drives can be arranged in the Direct voltage network. The auxiliary drives can be connected to or joined with the Direct voltage network. Additional power converters, in particular, additional inverters, can be arranged between the auxiliary drives and the Direct voltage network.

The screed heating system of the road construction machine can be supplied with energy from the electric machine and/or the battery. The auxiliary drive(s) of the road construction machine can be supplied with energy from the electric machine and/or the battery. The auxiliary drives and/or the screed heating system can be connected in series. The auxiliary drives and/or the screed heating system can be connected in a manner that can be coupled to the electric machine or the battery, respectively. The auxiliary drives and/or the screed heating system can be connected in a manner that can be coupled to the direct voltage network.

The electric machine can be configured to supply the direct voltage network with energy, in particular, when operated as a generator. The electric machine can be configured to be operated with energy from the Direct voltage network, in particular, when operated as a motor. The direct voltage network can be configured to be supplied with energy from the electric machine and/or to supply the electric machine with energy. The direct voltage network can be configured to be supplied with energy from the battery and/or to supply the battery with energy.

When the electric machine is operated as a generator, energy is fed from the electric machine via the direct voltage network to the battery. When the electric machine is operated as a motor, energy is fed from the battery to the electric machine.

The battery can be directly connected to the Direct voltage network.

The road construction machine can comprise a first power converter, in particular, a first inverter. The first power converter/inverter can be arranged between the Direct voltage network, in particular, the battery, and the screed heating system. The term “arranged between” is understood by the person skilled in the art to mean, in particular, that the component is connected (directly or indirectly) to both adjacent components. Accordingly, the first power converter/inverter is connected to the direct voltage network or the battery, respectively, as well as to the screed heating system. The road construction machine can comprise a first transformer. The first transformer can be arranged between the first power converter/inverter and the screed heating system.

The road construction machine can comprise a first auxiliary drive which is, in particular, arranged in the direct voltage network or connected thereto, respectively. The road construction machine can comprise a second power converter, in particular, a second inverter. The second power converter/inverter can be arranged between the Direct voltage network, in particular, the battery, and the first auxiliary drive. The first auxiliary drive can be supplied with energy from the battery and/or the electric machine.

The road construction machine can comprise a second auxiliary drive which is arranged, in particular, in the direct voltage network or connected thereto, respectively. The road construction machine can comprise a third power converter, in particular, a third inverter. The third power converter/inverter can be arranged between the Direct voltage network, in particular, the battery, and the second auxiliary drive. The second auxiliary drive can be supplied with energy from the battery and/or the electric machine.

The road construction machine can comprise a third auxiliary drive which is arranged, in particular, in the direct voltage network or connected thereto, respectively. The road construction machine can comprise a fourth power converter, in particular, a fourth inverter. The fourth power converter/inverter can be arranged between the Direct voltage network, in particular, the battery, and the third auxiliary drive. The third auxiliary drive can be supplied with energy from the battery and/or the electric machine.

The first auxiliary drive, the second auxiliary drive, and/or the third auxiliary drive are, in particular, connected in parallel.

The person skilled in the art will understand that the road construction machine can comprise further auxiliary drives and, accordingly, further associated power converters, in particular, inverters. For example, the road construction machine can also comprise four, five, six, or more auxiliary drives. The auxiliary drives are, in particular, connected in parallel. The auxiliary drives can be supplied with energy from the battery and/or the electric machine.

The road construction machine can comprise a first rectifier. The first rectifier can be arranged between an alternating voltage network, for example, a public power grid, and the Direct voltage network, in particular, the battery. The battery can be supplied or charged with energy from the Direct voltage network. The electric machine can be supplied or operated with energy from the Direct voltage network. The road construction machine can be configured to be connected to the alternating voltage network.

The road construction machine can be configured to be connected to a charging station, in particular, a direct voltage charging station. The charging station is, in particular, connected to the Direct voltage network. The battery can be charged with energy from the Direct voltage network.

The road construction machine can comprise a bidirectional power converter. The bidirectional power converter can be arranged between the Direct voltage network, in particular, the battery, the screed heating system, the auxiliary drives, the alternating voltage network and/or the charging station, and the electric machine.

The bidirectional power converter can be configured to convert direct current into alternating current, in particular, when the electric machine is operated as a motor. When the electric machine is operated as a motor, the bidirectional power converter is supplied, in particular, with direct current from the Direct voltage network, in particular, from the battery, and converts it into alternating current so that the electric machine can be operated with the converted alternating current.

The bidirectional power converter can be configured to convert alternating current into direct current, in particular, when the electric machine is operated as a generator. When the electric machine is operated as a generator, the bidirectional power converter is supplied, in particular, with alternating current from the electric machine and converts it into direct current so that the battery, the screed heating system, and/or the auxiliary drives can be supplied therewith. Instead of the bidirectional power converter, two separate power converters, in particular, a rectifier and an inverter, can also be provided.

The direct voltage network can be arranged between the electric machine and the battery. The direct voltage network can be arranged between the bidirectional power converter and the battery. The direct voltage network can be arranged between the electric machine or the bidirectional power converter, respectively, and the alternating voltage network. The direct voltage network can be arranged between the electric machine or the bidirectional power converter, respectively, and the charging station. The direct voltage network can be arranged between the battery and the screed heating system. The direct voltage network can be arranged between the battery and one or several auxiliary drives. The direct voltage network can connect the electric machine or the bidirectional power converter, respectively, to the battery, the screed heating system, and/or the auxiliary drives. The direct voltage network can connect the battery to the electric machine or the bidirectional power converter, the screed heating system, and/or the auxiliary drives, respectively.

As explained above, the first transformer can be arranged between the Direct voltage network, in particular, the battery or the first inverter, and the screed heating system, respectively. In this case, the direct voltage network or the bidirectional power converter, respectively, is arranged, in particular, between the screed heating system and the electric machine. The screed heating system is then supplied with energy, in particular, via the Direct voltage network. Alternatively, the screed heating system can be arranged between the electric machine, in particular, the externally excited synchronous machine, and the direct voltage network or the bidirectional power converter. The screed heating system can be connected, in particular, directly to the electric machine, in particular, in a manner that can be coupled. The screed heating system can then be supplied, in particular directly, with energy, in particular, alternating current, from the electric machine, in particular, when the electric machine is operated as a generator. In this case, the first transformer can be arranged between the electric machine or the screed heating system, respectively, and the bidirectional power converter. The connection between the screed heating system and the first transformer can be formed, in particular, in a manner that can be coupled. The connection between the electric machine and the first transformer can be formed, in particular, in a manner that can be coupled. The connection between the electric machine and the screed heating system can be formed, in particular, in a manner that can be coupled. During the paving stop, the electric machine can then be disconnected from the screed heating system or the Direct voltage network, respectively. The screed heating system can be an AC heating system or a DC heating system.

The road construction machine can comprise a cooling system. The cooling system is configured to cool the electric machine.

The battery, the electric machine, and/or the cooling system can be fully integrated into the road construction machine or installed therein, respectively. The battery and/or the cooling system can be configured as a module. The module can be attached in a manner that can be coupled to or mounted on the road construction machine. Even with the modular concept, the electric machine can be integrated into the road construction machine or installed therein.

The road construction machine can comprise a second transmission, in particular, a second transfer gearing or second pump transfer gearing. The road construction machine can comprise a second electric machine, in particular, a motor. The second electric machine can be connected to the battery and/or the first electric machine. The second electric machine can be configured to drive the second transmission. The second transmission can be connected to additional loads. For example, the first transmission can be connected to a pump, in particular, a hydraulic pump. The first transmission can be configured to drive the pump. The second transmission can be connected to a travel drive of the road construction machine. The second transmission can be configured to drive the travel drive of the road construction machine.

According to a second aspect of the disclosure, a method for operating a road construction machine comprises at least a first step and a second step. The road construction machine comprises at least one primary drive, at least one electric machine, and at least one transmission. In the first step, the transmission is driven by the primary drive. In the first step, the electric machine can be operated as a generator via the transmission. In the second step, the transmission is driven by the electric machine. In the second step, the electric machine is operated as a motor. The first and the second steps do not have to occur chronologically. The first step can occur before the second step. The first step can occur after the second step.

The road construction machine is configured, in particular, like the road construction machine according to the first aspect of the disclosure. The road construction machine is, in particular, a paving machine or a feeder vehicle for a paving machine. In the second step, the primary drive can be decoupled from the transmission.

When the electric machine is operated as a generator, the battery of the road construction machine can be charged, in particular, in the first step. The battery is charged, in particular, with energy generated by the electric machine. When the electric machine is operated as a motor, the electric machine is operated with energy from the battery, in particular, in the second step. The energy stored in the battery during operation as a generator is used during operation as a motor to drive the electric machine.

Alternatively or additionally, the battery can be charged via a charging station, in particular, a DC charging station. Alternatively or additionally, the battery can be charged via an alternating voltage network, in particular, the public power grid, whereby the alternating current from the alternating voltage network is first converted into direct current using a rectifier.

The primary drive can also drive the transmission in the second step, i.e., when the electric machine is operated as a motor. In the second step, the transmission is driven, in particular, by the primary drive and the electric machine. The motor operation of the electric machine is used, in particular, to compensate for load peaks. This allows the primary drive to be of a smaller size.

When the electric machine is operated as a generator or in the first step, respectively, the bidirectional power converter can be used as a rectifier. In the first step, the bidirectional power converter or a separate rectifier, respectively, converts, in particular, alternating current (from the electric machine) into direct current (for the direct voltage network or the battery).

When the electric machine is operated as a motor or in the second step, respectively, the bidirectional power converter can be used as an inverter. In the second step, the bidirectional power converter or a separate inverter, respectively, converts, in particular, direct current (from the battery or the Direct voltage network) into alternating current (for the electric machine).

The road construction machine can comprise a load, in particular, the screed heating system described above. During a paving state of the road construction machine, the load can be connected to the electric machine and be supplied with energy from the electric machine. During a paving stop of the road construction machine, the load can be disconnected from the electric machine and be supplied with energy from the battery or the Direct voltage network, respectively.

The method can further comprise supplying a first auxiliary drive with energy, in particular, via a Direct voltage network. The method can further comprise supplying a second auxiliary drive with energy, in particular, via a Direct voltage network. The method can further comprise supplying a third auxiliary drive with energy, in particular, via a Direct voltage network. The person skilled in the art will understand that further auxiliary drives can also be supplied with energy.

When the electric machine is operated as a generator or in the first step, respectively, the first, second, and/or third auxiliary drive (or also the further auxiliary drives) can be supplied with energy from the electric machine and/or the battery. When the electric machine is operated as a motor or in the second step, respectively, the first, second, and/or third auxiliary drive (or also the further auxiliary drives) can be supplied with energy from the battery.

The method can additionally comprise converting direct voltage from the direct voltage network or the battery, respectively, into alternating voltage so that the auxiliary drives and/or the screed heating system can be operated with alternating voltage.

In a third step, the transmission can be driven by the primary drive, and the electric machine can be decoupled from the transmission. This can prevent, in particular, drag losses. The first, second, and/or third step can occur in any order. Additional steps can occur between the first, second, and/or third step.

A third aspect of the disclosure comprises the use of a parallel hybrid drive comprising an internal combustion engine and an electric machine in a road construction machine. The road construction machine is, in particular, a paving machine. The road construction machine can be configured according to the first aspect of the disclosure. The electric machine is configured, in particular, to be operated as a motor and a generator.

The road construction machine according to the first aspect of the disclosure can be used with method steps of the method according to the second aspect of the disclosure. The method according to the second aspect of the disclosure can be carried out with a road construction machine according to the first aspect of the disclosure. The road construction machine according to the first aspect of the disclosure can be used according to the use of the third aspect of the disclosure.

As used in the description of the various embodiments described and the claims appended, the singular forms are to be understood to include the plural forms and vice versa, unless the context clearly indicates otherwise.

The terms “first,” “second,” “third,” and “fourth” are to be understood merely as designations for a specific element or component and do not necessarily indicate a particular order or arrangement of the components or elements mentioned. For example, the presence of a fourth element does not necessarily imply the presence of a first, second, or third element, and vice versa.

### BRIEF DESCRIPTION OF THE DRAWINGS

Advantageous embodiments of the disclosure shall be explained in more detail below with reference to the figures appended.

FIG. 1 shows a side view of a road construction machine according to the disclosure in the form of a paving machine;

FIG. 2 shows a schematic representation of a drive system known from prior art;

FIG. 3 shows a schematic representation of a first embodiment of a drive system of a road construction machine according to the disclosure;

FIG. 4 shows a schematic representation of a second embodiment of a drive system of a road construction machine according to the disclosure;

FIG. 5 shows a schematic representation of a third embodiment of a drive system of a road construction machine according to the disclosure; and

FIG. 6 shows a schematic representation of a further embodiment of a drive system of a road construction machine according to the disclosure.

### DETAILED DESCRIPTION

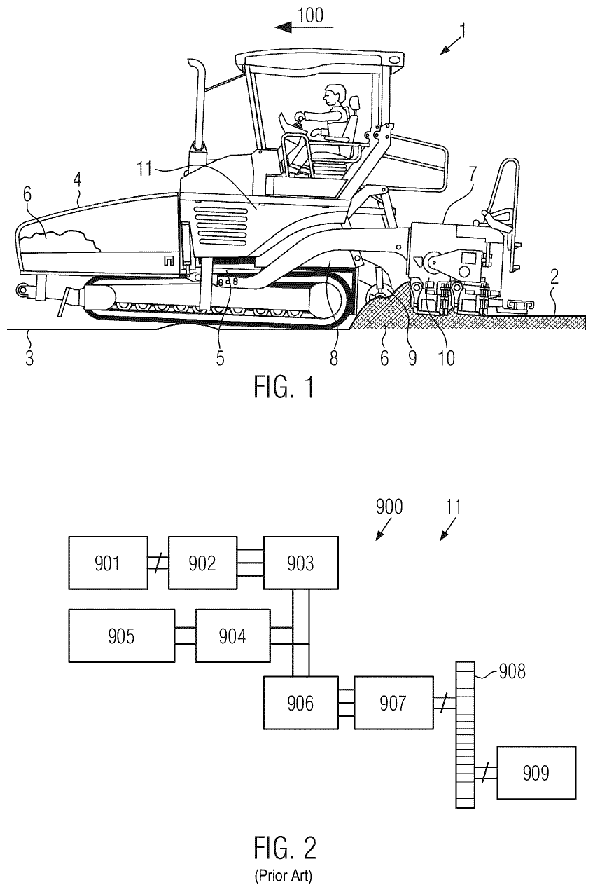

FIG. 1 shows a side view of a road construction machine 1 according to the disclosure in the form of a paving machine. Paving machine 1 is configured to produce a paving layer 2 on a road bed 3. Paving machine 1 comprises a material hopper 4 in paving direction of travel 100 at the front, from which a paving material 6 contained therein is transported to a paving screed 7 of paving machine 1 by way of a material transport device 5 (e.g., one or more belt conveyors, endless conveyor belts, drag-chain conveyors, or slat conveyors) in the direction opposite to paving direction of travel 100 of paving machine 1. Material transport device 5 is arranged within a chassis 8 of paving machine 1 and initially transports paving material 6 to a transverse distribution device 9 (e.g., one or more screw conveyors or augers) arranged in paving direction 100 of travel forward of paving screed 7. Transverse distribution device 9 is configured to distribute paving material 6 in front of paving screed 7 along a transverse direction transverse to paving direction 100 of travel. Paving machine 1 can comprise a screed heating system 10 configured to heat paving screed 7, in particular, to a predetermined temperature. The paving machine additionally comprises a drive system 11.

A drive system 11 known from prior art in the form of a serial hybrid drive 900 is illustrated schematically in FIG. 2. The serial hybrid drive comprises a primary drive 901 in the form of an internal combustion engine. Internal combustion engine 901 drives a generator 902. The alternating voltage generated by generator 902 is converted into direct voltage in a rectifier 903. Rectifier 903 is connected to a battery 905 by way of a DC-DC converter 904. Serial hybrid drive 900 furthermore comprises an inverter 906 and an electric motor 907. Inverter 906 converts the direct voltage provided by rectifier 903 or battery 905 into alternating voltage so that electric motor 907 can be operated therewith. Electric motor 907 is connected to a transmission 908 and drives it. A load 909, for example, in the form of a hydraulic pump, is arranged at an output of transmission 908 and is driven by transmission 908. In serial hybrid drive shown in FIG. 2, mechanical energy is first generated by internal combustion engine 901. It is thereafter first converted into electrical energy by generator 902. The electrical energy is then converted back to mechanical energy by electric motor 907 and fed via transmission 908 to hydraulic pump 909. In hydraulic pump 909, the mechanical energy is converted into hydraulic energy which is subsequently converted into mechanical energy in main loads, for example, in a travel drive (e.g., drivetrain, which may include one or more axles, track drives or hydrostatic drives) or a material transport of paving machine 1.

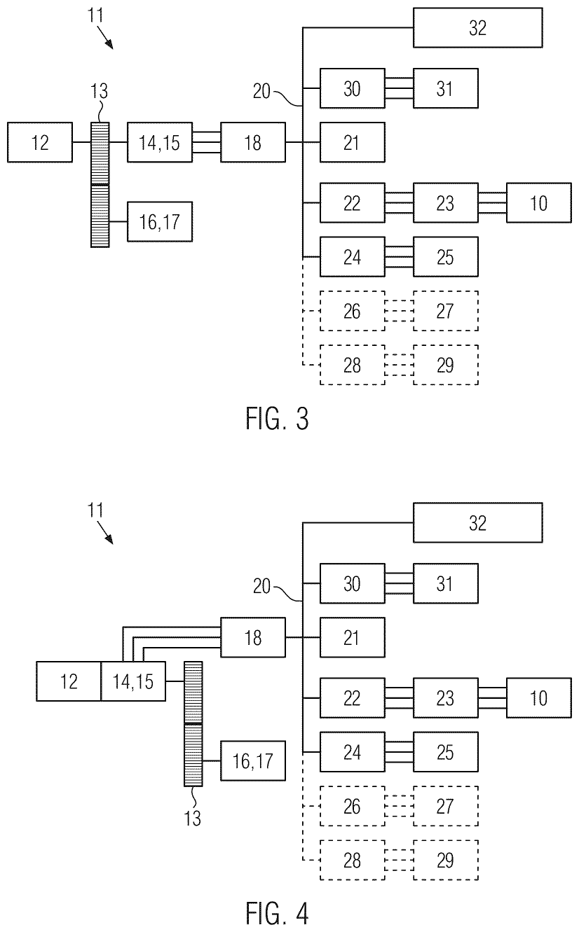

FIG. 3 shows a schematic representation of a first embodiment of a drive system 11 of a road construction machine 1. Drive system 11 comprises a primary drive 12 in the form of an internal combustion engine, for example, a diesel or gasoline engine. Primary drive 12 is connected to a transmission 13, is, in particular, coupled thereto in a detachable manner, and is configured to drive transmission 13. Transmission 13 can be a pump transfer gearing 13. An electric machine 14, in particular, in the form of a permanent magnet synchronous machine (PSM) 15, is arranged at an output of transmission 13. Electric machine 14 is separably coupled to transmission 13. Furthermore, at least one load 16, in particular, in the form of a hydraulic pump 17, is connected to transmission 13 and is driven via transmission 13. At least one load 16 can be, for example, associated with or comprised in a travel drive or a material transport system.

Electric machine 14 is configured to be operated as a generator and a motor. During operation as a generator, alternating current is generated in electric machine 14, in particular, from mechanical energy which is transmitted from primary drive 12 via transmission 13 to electric machine 14.

In comparison to serial drive systems for road construction machines 1 known from prior art, as shown in FIG. 2, the mechanical energy in drive system 11 according to the disclosure generated by primary drive 12 is not first converted into electrical energy, but is fed directly to transmission 13.

Drive system 11 comprises a power converter 18, in particular, in the form of a bidirectional power converter. Alternatively, power converter 18 can be formed from two separate inverters and rectifiers. When the electric machine 14 is operated as a generator, the bidirectional power converter converts the alternating voltage generated by electric machine 14 into direct voltage. A direct voltage network 20 is connected to bidirectional power converter 18. Direct voltage network 20 connects bidirectional power converter 18 to a battery 21 comprised in paving machine 1. When electric machine 14 is operated as a generator, battery 21 can be charged with energy from electric machine 14.

A first power converter 22 in the form of a first inverter can be connected to direct voltage network 20. First inverter 22 is connected to screed heating system 10 of paving machine 1 via a first transformer 23. First inverter 22 converts the direct voltage present in direct voltage network 20 into alternating voltage. First transformer 23 adapts the alternating voltage that is present to the alternating voltage that is required by screed heating system 10.

A second power converter 24 in the form of a second inverter can be connected to direct voltage network 20. Second inverter 24 is connected to a first auxiliary drive 25 of paving machine 1. Second inverter 24 converts the direct voltage present in direct voltage network 20 into Alternating voltage and conducts it to first auxiliary drive 25. The person skilled in the art will understand that road construction machine 1 can comprise further auxiliary drives. Two further auxiliary drives are shown by way of example in FIG. 3, as described below.

A third power converter 26 in the form of a third inverter can be connected to direct voltage network 20. Third inverter 26 is connected to a second auxiliary drive 27 of paving machine 1. Third inverter 26 converts the direct voltage present in direct voltage network 20 into Alternating voltage and transmits it to second auxiliary drive 27.

A fourth power converter 28 in the form of a fourth inverter can be connected to direct voltage network 20. Fourth inverter 28 is connected to a third auxiliary drive 29 of paving machine 1. Fourth inverter 28 converts the direct voltage present in direct voltage network 20 into alternating voltage and conducts it to third auxiliary drive 29. The person skilled in the art will understand that road construction machine 1 can comprise still further auxiliary drives. Depending on the required voltage type, road construction machine 1 can also comprise further power converters in the form of inverters.

Screed heating system 10 and/or one or more of auxiliary drives 25, 27, 29 can be operated with energy from battery 21.

Paving machine 1 can additionally comprise a rectifier 30. Rectifier 30 is configured to convert alternating voltage from an alternating voltage network 31, in particular, the public power grid, into direct voltage. Battery 21 can then be charged with energy from alternating voltage network 31. Screed heating system 10 and/or one or more of auxiliary drives 25, 27, 29 can be operated with energy from alternating voltage network 31.

Paving machine 1, in particular, direct voltage network 20, can be configured to be connected to a charging station 32 in the form of a DC charging station. Battery 21 can then be charged with energy from charging station 32. Screed heating system 10 and/or one or more of auxiliary drives 25, 27, 29 can be operated with energy from charging station 32.

Auxiliary drives 25, 27, 29 are, in particular, electric auxiliary drives. Screed heating system 10 and auxiliary drives 25, 27, 29 are connected in parallel.

When electric machine 14 is, in particular, permanent magnet synchronous machine 15, operated as a motor, electric machine 14 is powered by energy from battery 21, alternating current network 31, and/or charging station 32. Electric machine 14 drives transmission 13, in particular, the pump transfer gearing. This can occur in addition to or as an alternative to driving by primary drive 12.

FIG. 4 shows a second embodiment of a drive system 11 of a road construction machine 1 according to the disclosure. Direct voltage network 20 can be configured to be identical to the embodiment of FIG. 3. Transmission 13, bidirectional power converter 18, direct voltage network 20, battery 21, first power converter 22, first transformer 23, screed heating system 10, second power converter 24, first auxiliary drive 25, third power converter 26, second auxiliary drive 27, fourth power converter 28, third auxiliary drive 29, rectifier 30, alternating voltage network 31, and/or charging station 32 (as well as a combination thereof) can be configured and arranged to be identical to the embodiment of FIG. 3.

In contrast to the embodiment of FIG. 3, primary drive 12 and electric machine 14 in the embodiment of FIG. 4 are not connected to transmission 13 at different points. Instead of arranging electric machine 14 at an output of transmission 13, like in FIG. 3, electric machine 14 is arranged between primary drive 12 and transmission 13. Electric machine 14, in particular, represents a crankshaft generator. This design can offer installation space advantages. Primary drive 12 can be an internal combustion engine 12, like in FIG. 3. Electric machine 14 can be a permanent magnet synchronous machine 15, like in FIG. 3. Electric machine 14 in this embodiment can also be operated as a motor and generator.

One or more loads 16, in particular, one or more hydraulic pumps 17, can be configured to be identical to the embodiment in FIG. 3.

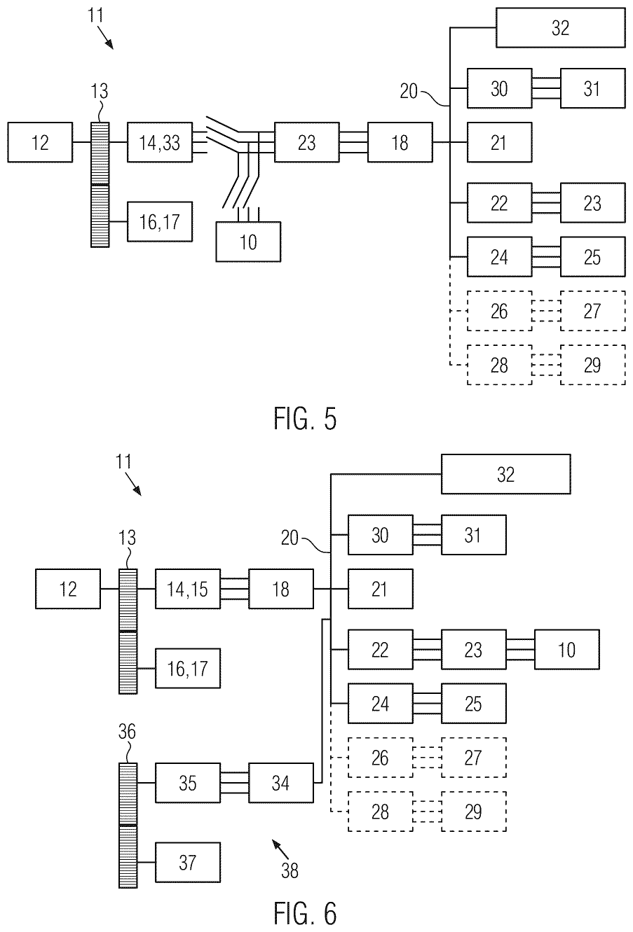

FIG. 5 shows a third embodiment of a drive system 11 of a road construction machine 1 according to the disclosure. Direct voltage network 20 can be configured to be identical to the embodiment in FIG. 3. Transmission 13, bidirectional power converter 18, direct voltage network 20, battery 21, second power converter 24, second transformer 24, first auxiliary drive 25, third power converter 26, second auxiliary drive 27, fourth power converter 28, third auxiliary drive 29, rectifier 30, alternating voltage network 31 and/or charging station 32 (and combinations thereof) can be configured and arranged to be identical to the embodiment of FIG. 3. One or more loads 16, in particular, one or more hydraulic pumps 17, can be configured to be identical to the embodiment in FIG. 3. Primary drive 12 can be an internal combustion engine 12, like in FIG. 3.

In contrast to the embodiments of FIGS. 3 and 4, electric machine 14 is an externally excited synchronous machine (FSM) 33. Externally excited synchronous machine 33 is arranged at an output of transmission 13 and connected to transmission 13. First transformer 23 is arranged between bidirectional power converter 18 and electric machine 14. Screed heating system 10 is connected directly to electric machine 14. Screed heating system 10 is connected, in particular, in a manner that can be coupled to electric machine 14 so that the former can be disconnected from electric machine 14. First transformer 23 is connected, in particular, in a manner that can be coupled to electric machine 14 such that it, and thereby direct voltage network 20, can be disconnected from electric machine 14. Screed heating system 10 is also connected in a manner that can be coupled to first transformer 23.

During a paving stop of paving machine 1, electric machine 14 can be disconnected from first transformer 23 and thereby from bidirectional power converter 18. Screed heating system 10 is then connected to bidirectional power converter 18 via first transformer 23. Screed heating system 10 is then supplied with energy from battery 21.

In this embodiment, electric machine 14, in particular, externally excited synchronous machine 33, can also be operated as a generator and as a motor. However, electric machine 14, in particular, externally excited synchronous machine 33, cannot be operated as a motor if screed heating system 10 is active at the same time.

FIG. 6 shows a further embodiment of a drive system 11 of a road construction machine 1 according to the disclosure and represents a development of the embodiments shown in FIGS. 3 to 5. The development is shown by way of example based on the embodiment shown in FIG. 3. However, the person skilled in the art will understand that this is also possible analogously with the embodiments of FIGS. 4 and 5.

The drive system comprises a fifth inverter 34 which is connected to direct voltage network 20. Fifth inverter 34 converts the direct voltage present in direct voltage network 20 into alternating voltage. An electric motor 35 is connected, in particular, in a manner that can be coupled, to fifth inverter 34. Electric motor 35 is supplied with energy from electric machine 14 and/or battery 21, in particular, through direct voltage network 20. Alternatively or additionally, electric motor 35 is supplied with energy from charging station 32 and/or alternating voltage network 31, in particular, through direct voltage network 20. Electric motor 35 drives a second transmission 36. Second transmission 13 can be a pump transfer gearing. Second transmission 36 can be configured to be identical to transmission 13. Second transmission 36 can be configured to be different from transmission 13. At least one further load 37 is arranged at an output of second transmission 36. At least one further load 37 can be connected to second transmission 36 in a manner that can be coupled. At least one load 37 can be a hydraulic pump. At least one further load 37 is supplied with energy by electric motor 35 via second transmission 36. Several further loads 37 can be connected, in particular, in a manner that can be coupled, to second transmission 36.

Fifth inverter 34, electric motor 35, second transmission 36, and at least one further load 37 are referred to, in particular, as electric auxiliary drive 38. Electric auxiliary drive 38 is connected to electric machine 14 and/or battery 21 through direct voltage network 20. Road construction machine 1 can comprise multiple electric auxiliary drives 38, for example, two, three, or four electric auxiliary drives 38. Auxiliary drives 38 can all be connected separately (in series) to direct voltage network 20. Only one electric auxiliary drive 38 is shown in FIG. 6 by way of example. The embodiments shown in FIGS. 4 and 5 can also be expanded to include one or more electric auxiliary drives 38.

What is claimed is:

1. A road construction machine comprising:
a primary drive;
an electric machine;
a transmission; and
at least one load connected to the transmission;
wherein the primary drive and the electric machine are also connected to the transmission, and wherein the electric machine is configured to be operated as a generator and a motor.

2. The road construction machine according to claim 1, wherein the primary drive and the electric machine are connected to the transmission in a force-transmitting, power-transmitting, and/or energy-transmitting manner.

3. The road construction machine according to claim 1, wherein the primary drive and the electric machine are each connected to the transmission directly or by way of a clutch, or the electric machine is connected to the transmission directly or by way of a clutch, and the primary drive is indirectly connected to the transmission via the electric machine.

4. The road construction machine according to claim 1, wherein the primary drive and the electric machine are each connected to the transmission directly or by way of a hydraulic clutch and/or a friction clutch, or the electric machine is connected to the transmission directly or by way of a hydraulic clutch and/or a friction clutch, and the primary drive is indirectly connected to the transmission via the electric machine.

5. The road construction machine according to claim 1, wherein no conversion into electrical energy takes place between the primary drive and the transmission.

6. The road construction machine according to claim 1, further comprising a battery, wherein the electric machine is configured to charge the battery with energy generated and/or the electric machine is configured to be operated with energy from the battery.

7. The road construction machine according to claim 6, wherein the battery comprises a high-voltage battery.

8. The road construction machine according to claim 1, wherein the primary drive is configured to drive the transmission mechanically and/or hydraulically.

9. The road construction machine according to claim 1, wherein the primary drive comprises an internal combustion engine.

10. The road construction machine according to claim 9, wherein the internal combustion engine comprises a diesel engine, a hydrogen engine, a gas engine, or a gasoline engine.

11. The road construction machine according to claim 1, wherein the electrical machine comprises an electromechanical converter.

12. The road construction machine according to claim 11, wherein the electromechanical converter comprises a permanent magnet synchronous machine, an asynchronous machine, a reluctance machine, an externally excited synchronous machine, or a combination thereof.

13. The road construction machine according to claim 1, wherein the at least one load comprises a pump with a variable or constant displacement volume, a travel drive, a transverse distribution device, and/or a material transport device, which can be connected to outputs of the transmission.

14. The road construction machine according to claim 1, further comprising a battery and a direct voltage network configured to supply a screed heating system of the road construction machine and/or auxiliary drives of the road construction machine with energy, wherein the direct voltage network is configured to receive energy from the electric machine and/or the battery.

15. The road construction machine according to claim 14, wherein the screed heating system of the road construction machine is arranged between the electric machine and the direct voltage network, and wherein the screed heating system is connected between the electric machine and the direct voltage network or directly to the electric machine.

16. A method for operating a road construction machine, the road construction machine comprising at least one primary drive, at least one electric machine, and at least one transmission, the method comprising:
in a first step, driving the transmission by the primary drive, and operating the electric machine as a generator via the transmission, and
in a second step, operating the electric machine as a motor, and driving the transmission by the electric machine.

17. The method for operating a road construction machine according to claim 16, wherein, when the electric machine is operated as a generator, a battery of the road construction machine is charged with energy, and when the electric machine is operated as a motor, the electric machine is operated with energy from the battery.

18. The method for operating a road construction machine according to claim 16, wherein the road construction machine comprises a load, wherein, during a paving state of the road construction machine, the load is connected to the electric machine and is supplied with energy from the electric machine, and during a paving stop of the road construction machine, the load is disconnected from the electric machine and is supplied with energy from a battery.

19. The method according to claim 18, wherein the load comprises a screed heating system.

20. The method for operating a road construction machine according to claim 16, wherein, in a third step, the transmission is driven by the primary drive, and the electric machine is decoupled from the transmission.
